(19) United States
(12) Patent Application Publication
(10) Pub. No.: US 2009/0255180 A1
(43) Pub. Date: Oct. 15, 2009

(54) Nutrient-holding and flow control system for in-line connection with water flow to plants or planters

(75) Inventors: Wilson A. Felknor, Lenoir City, TN (US); Jim Ferron, Loudon, TN (US)

Correspondence Address: MICHAEL E. MCKEE;Attorney at Law, 804 Swaps Lane, Knoxville, TN, 37923, US

(73) Assignee: Felknor Ventures, LLC.

(21) Appl. No.: 12/380,317

(22) Filed: Feb. 26, 2009

Related U.S. Application Data
(60) Provisional application No. 61/123,773, filed on Apr. 12, 2008.

(51) Int. Cl. A01G 25/16; A01G 25/00

(52) U.S. Cl. 47/62 N

(57) ABSTRACT

A nutrient-holding and flow control system (22) for connection in-line with the flow of water to a plant includes a receptacle (50) having an interior (82) into which nutrients (84) can be positioned and including an inlet port (104) into which water is permitted to flow into the interior of the receptacle and an outlet port (108) through which water and nutrients are permitted to exit the interior of the receptacle and flow toward a plant. In addition, a flow controller (52) is associated with the receptacle for permitting a user to adjust the flow rate of water through the receptacle.

The benefit of Provisional Application Ser. No. 61/123,773, filed Apr. 12, 2008 and entitled PLANTER ASSEMBLY FOR GROWING MULTIPLE PLANTS AND ASSOCIATED IRRIGATION SYSTEM, is hereby claimed. The disclosure of this referenced provisional patent application is incorporated herein by reference.

### BACKGROUND OF THE INVENTION

This invention relates generally to gardening accessories and relates, more particularly, to means and methods with which fertilizer and other nutrients are delivered to a plant for growth and with which the flow rate of water to the plant is controlled.

During the growth of a plant in a controlled environment, such as in a greenhouse or planter, water and plant nutrients are delivered to the plant to keep the plant vital and growing. For this purpose, a water line, such as a garden hose, can be used to conduct water from a source, such as water faucet, to the plant, and nutrients are often delivered manually to an area of the soil adjacent the plant.

It would be desirable to provide a means by which plant fertilizer or other nutrients can be delivered to the plant as water is also delivered to the plant.

Accordingly, it is an object of the present invention to provide a new and improved system enabling plant nutrients to be delivered to the plant each time that water is delivered to the plant so that both water and nutrients are delivered to the plant simultaneously and so that the nutrients are delivered relatively evenly over a targeted area adjacent a plant or plants to be fed.

Another object of the present invention is to provide such a system which is connectable in-line with the water supply conducted from a source and so that nutrients are delivered to the plant at a controlled, or metered, rate.

Still another object is to provide such a system enabling a user to make adjustments to the flow of water to the plant without requiring that such adjustments be made to the water flow at the source, such as at a water faucet.

Yet another object of the present invention is to provide such a system which is uncomplicated in structure, yet effective in operation.

### SUMMARY OF THE INVENTION

This invention resides in a nutrient-holding and flow control system for connection in-line with the flow of water for delivery to a plant.

The system includes a receptacle having an interior into which nutrients can be positioned and including an inlet port into which water is permitted to flow into the interior of the receptacle from a source and an outlet port through which water and nutrients are permitted to exit the interior of the receptacle for delivery of water and nutrients from the receptacle to the plant. In addition, a flow controller is associated with the receptacle for permitting a user to adjust the flow rate of water through the receptacle.

### BRIEF DESCRIPTION OF THE DRAWINGS

FIG. 1 is a side elevational view illustrating schematically a water and nutrient-delivery system for delivery of water and nutrients to a hanging planter.

FIG. 2 is a view of selected components of the water and nutrient-delivery system of FIG. 1, but drawn to a slightly larger scale.

FIG. 3 is a perspective view of the components illustrated in FIG. 2.

FIG. 4 is a perspective view of the receptacle of the components illustrated in FIG. 3, shown exploded.

FIG. 5 is a perspective view of the flow controller of the components illustrated in FIG. 3, shown exploded.

### DETAILED DESCRIPTION OF AN ILLUSTRATIVE EMBODIMENT

Turning now to the drawings in greater detail and considering first FIG. 1, there is illustrated a water and nutrient-delivery system, generally indicated 20, with which a nutrient-holding and flow control system, generally indicated 22, is embodied for delivering water and nutrients to a stand-supported planter 24.

The stand-supported planter 24 includes a stand 26 adapted to rest upon a floor 28 or similar underlying structure and a container 30 for holding dirt or potting soil and within which plants are transplanted for growth. Briefly, the stand 26 includes a leg assembly and a center post 32 which is supported in a substantially vertical orientation by the leg assembly, and there is provided a hanger system 34 including a plurality of cables 36 for suspending the container 30 from the upper end of the center post 32 in an elevated condition above the floor 28. The container 30 is an open-topped container within which a plant is transplanted for growth, and any water or nutrients added to the interior of the container 30 to promote plant growth therein is typically added to the container 30 through the open top thereof.

It will be understood that the depicted planter 24 is intended to provide an example of a class of planters with which the nutrient-holding and flow control system in accordance with the present invention can be utilized. The planter 24 can, for example, take the form of a vertical hanging grow bag or a common hanging basket. Accordingly, the principles of the present invention can be variously applied.

The water and nutrient-delivery system 20 includes a network, indicated 40, of conduits, described herein for delivery of water to the planter 24 from a source 42. In the depicted system 20, the source 42 of water is accessible through a water faucet 44 having an externally-threaded spout 46. In addition, the system 22 includes a nutrient-holding receptacle, or receptacle means, 50 and associated flow controller, or flow control means, 52. In the depicted system 20, the receptacle means 50 and the flow control means 52 are connected in flow communication by a conduit, or hose, portion 54, but the two items 50 and 52 can be directly coupled together in accordance with the broader aspects of the present invention.

The conduit network 40 of the depicted system 20 includes the conduit portion 54 (introduced earlier) and a conduit portion 56 which extends between the nutrient-holding assembly 50 the top of the container 30. The depicted conduit portion 54 includes a vertically-disposed section which extends upwardly along the center post 32 of the stand 26 and another, or horizontally-disposed, section which extends along the floor 28. Therefore, water which is conducted from the faucet 44 to the top of the container 30 travels in sequence through the flow control means 52, the conduit portion 54, the receptacle means 50 and the conduit portion 56. Upon exiting the exit end, indicated 58, of the conduit portion 56—which end 58 is situated above the top of the container 30, the water is permitted to gravitationally flow downwardly into the container 30 where it is exposed to a plant (or plants) growing therein.

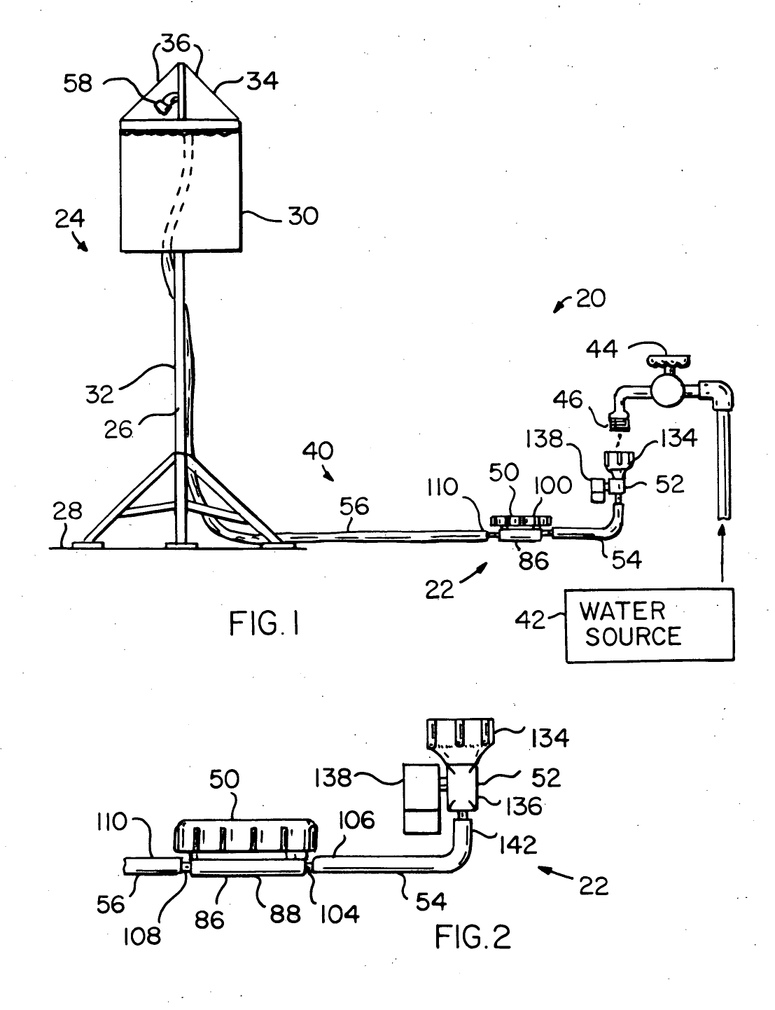

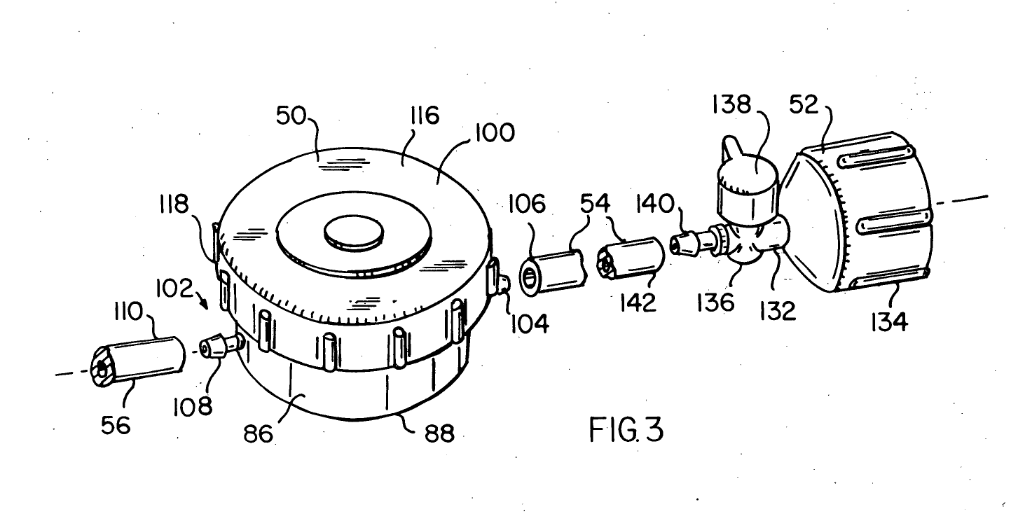

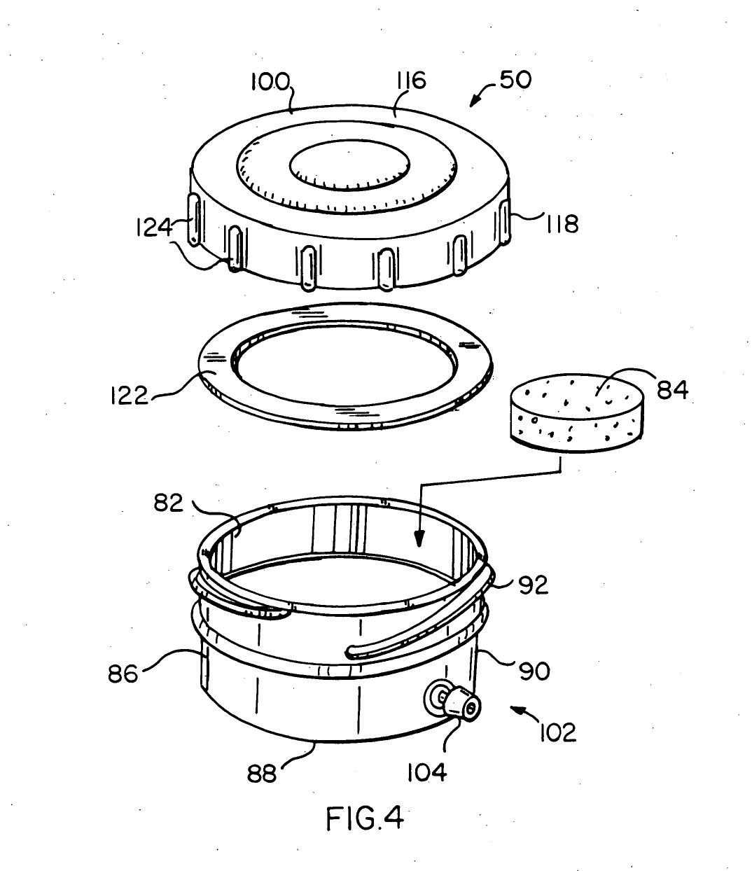

With reference to FIGS. 2-4, the nutrient-holding receptacle means 50 is somewhat jar-shaped in form and defines an interior 82 adapted to hold an amount of nutrients (such as a fertilizer tablet 84 illustrated in FIG. 4) for mixing with water directed through the receptacle means 50 on its way to the container 30 of the planter 24. To this end, the receptacle means 50 includes an open-topped compartment 86 having a planar bottom 88 and cylindrical sidewalls 90 and further includes a removable cap 100. Defined along the sidewalls 90 of the compartment 86 and adjacent the top thereof are external threads 92 which cooperate with the cap 100 to permit the cap 100 to be threadably secured about the compartment 86 and thereby cover the open top thereof.

Furthermore, the receptacle means 50 includes port means, generally indicated 102, which accommodate the attachment of a corresponding conduit portion 54 or 56 to the receptacle means 50 and to thereby permit the flow of water therethrough. More specifically, the port means 102 includes an inlet port 104 disposed on one side of the compartment 86 which permits the attachment of the exit end, indicated 106, of the conduit portion 54 to the receptacle means 50. In the depicted receptacle means 50, the inlet port 104 is sized to be received by the exit end 106 when the exit end 106 is directed endwise over the inlet port 104 to a snug-fitting relationship thereabout.

The port means 102 also includes an outlet port 108 disposed on the side of the compartment 86 opposite the inlet port 104 which permits the attachment of the inlet end, indicated 110, of the conduit portion 56 to the receptacle means 50. In the depicted receptacle means 50, the outlet port 108 is sized to be received by the inlet end 110 as the inlet end 110 is directed endwise onto the outlet port 108 to a snug-fitting relationship thereabout. If desired, the compartment 86 and the inlet and outlet ports 104 and 108 can be molded as a unitary structure out of a relatively hard plastic material. Furthermore, each of the inlet and outlet ports 104 and 108 is preferably provided with a barbed outer surface, as shown in FIGS. 3 and 4, to enhance the securement between the port and the conduit portion connected to the port.

The removable cap 100 of the receptacle means 50 includes a platen cover portion 116 and cylindrical sidewalls 118 which extend downwardly (as viewed in FIG. 4) from the cover portion 116. The interior surfaces of the sidewalls 118 are provided with internal threads which cooperate with the external threads 92 (FIG. 4) of the compartment 86 so that the cap 100 can be threadably attached to the compartment 86 by screwing the cap 100 about the compartment 86 (to thereby close the open top of the compartment 86) or removed from the compartment 86 by unscrewing the cap from the compartment 86 (to thereby provide access to the interior 82 of the receptacle means 50). As is the case with the compartment 86, the cap 100 can also be formed, or molded, out of plastic material; and if desired, the exterior surface of the cap sidewalls 118 can be provided with axially-extending protuberances 124 which are regularly spaced around the cap 100 to increase the ease with which the cap 100 can be gripped.

To ensure a tight seal between the surfaces of the cap 100 and the compartment 86, the receptacle means 50 preferably includes a flat washer 122 constructed, for example, of elastomeric material which is positionable along the edge of the compartment top so that when the removable cap 100 is tightened about the compartment 86, the washer 122 is tightly sandwiched between the top of the compartment 86 and the underside of the cover portion 116.

It follows that the removable cap 100 provides a user with access to the interior 82 of the receptacle means 50. For use of the system 22 (and while the flow of water through the receptacle means 50 is shut off), the cap 100 is removed from the compartment 86 and then fertilizer or other plant nutrients (which may be in solid or liquid form and, in either event, is water soluable) is placed within the interior 82 of the receptacle means 50. The cap 100 is then replaced upon the compartment 84 to cover, and thereby close, the top thereof, and the water flow through the receptacle means 50 is turned ON. As water is routed into the receptacle means 50 (i.e. through the inlet port 104 thereof), the nutrients mix with (e.g. becomes entrained by or dissolve within) the water flow so that water which subsequently exits the receptacle means 50 through the outlet port 108 carries with it the entrained or dissolved fertilizer toward the planter container 30.

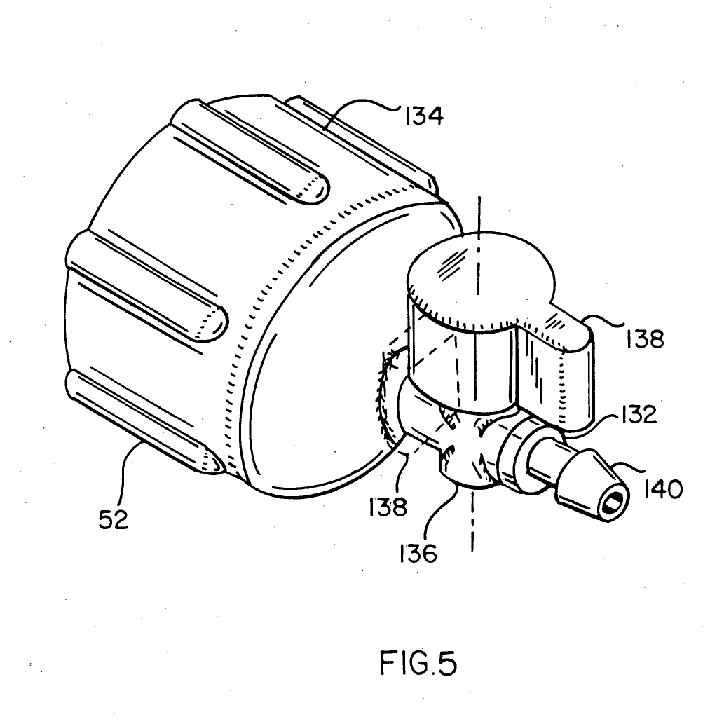

As mentioned above, there is associated with the nutrient-holding receptacle means 50 flow control means, generally indicated 52, for controlling the flow of water through the receptacle means 50. In this connection and with reference to FIGS. 3 and 5, the flow control means 52 includes a passageway-defining body 132 having a connector portion 134 which is adapted to be threadably connected to the externally-threaded spout 46 of the water faucet 44, and there is mounted within the body 132 a flow control valve 136 having an adjustment knob 138 which permits a user to adjust the rate of flow of the water flowing through the conduit 202 by rotating the knob 138 relative to the body 132 to alternative positions. Each component of the flow control means 52 can be molded, or formed, as a separately-identifiable component; and if desired, the exterior surface of the connector portion 134 can be provided with axially-extending protuberances which are regularly spaced therearound to improve the capacity of the connector portion 134 to be gripped by a user.

The flow control valve 136 of the depicted flow control means 130 is a ball-type, infinitely-variable valve whose position within the body 132 of the flow control means 130 can be adjusted between a fully ON orientation (as is illustrated in solid lines in FIG. 5) and a fully OFF position (as is illustrated in phantom in FIG. 5) so as to provide any desired flow rate between the fully ON condition or fully OFF condition (for providing a flow rate of zero through the valve 136). For example, if it is desired that the flow rate through the valve 136 be about midway between the fully ON and fully OFF conditions, the knob 138 should be moved relative to the valve 136 to a rotational position which is about half-way between its fully ON and fully OFF positions. It can be noted that the knob 138 is rotated relative to the body 132 through only about ninety degrees of angular movement as it is rotated between its fully ON and fully OFF positions. Thus, if it is desired to permit a relatively small, or drip, rate of fluid flow through the valve 136, the knob 138 would be rotated relative to the valve body 132 to a position disposed relatively close to, but not in, the fully OFF position.

For connection of the body 132 of the flow control means 130 to the conduit portion 54 of the conduit network 40, the body 132 includes an exit port 140 which is disposed downstream of the flow control valve 136 and in flow communication with the connector portion 134. In the depicted flow control means 130, the exit port 140 is sized to be received by the inlet end, indicated 142, of the conduit portion 54 when the inlet end 142 is directed endwise over the exit port 140 to a snug-fitting relationship thereabout. As is the case with the inlet and outlet ports 104 and 108 of the receptacle means 50, the exit port 140 is preferably provided with a barbed outer surface to enhance the securement between the port 140 and the inlet end 142 of the conduit portion 54.

Exemplary dimensions of various components of the system 20 are provided here as follows: The outer diameter of the removable cap 100 of the receptacle means 50 can be about 2.25 inches; the depth of the cap 100 can be about 1.2 inches; the wall thickness of the cap 100 can be about 0.070 inches; the outer diameter of the compartment 86 of the receptacle means 50 can be about 2.125 inches; the depth of the compartment 86 can be about 1.1 inches; each of the conduit portions 54 and 56 can be provided by a plastic hose having an outer diameter of 0.5 inches; and the ports 108, 104 and 140 (with the barbed connectors associated therewith) are sized to be snugly accepted by the conduit portions having the 0.5 inch outer diameter.

It follows from the foregoing that a water and nutrient-delivery system 20 has been described with which water and nutrients can be delivered to a planter 24. Furthermore, there is incorporated within the system 20 a nutrient-holding and flow control system 22 including a receptacle means 50 into which a user can deposit fertilizer or other plant nutrients for delivery to the planter 24 with water from a source 42 and including a flow control means 52 through which the user can control the rate of flow of water through the receptacle means 50. Thus, the receptacle means 50 and flow control means 82 provides a convenient and uncomplicated means by which water and fertilizer or other nutrients can be delivered simultaneously to the container 30 of the planter 24 at a metered rate and allows a user to control the flow rate of water through the receptacle means 50 and into the container 30 without having to control the water flow at the faucet 44.

It is envisioned that the aforedescribed system 20 is particularly well-suited for delivering liquid fertilizer (which is poured into the receptacle means 50) to the container 30 at a relatively slow rate, and provides a user with an alternative to known, more-costly greenhouse watering and feeding drip systems. In other words, because the system 20 need not involve the relatively sophisticated equipment commonly associated with greenhouse watering and feeding drip systems, such as can involve timers, nutrient barrels, water lines and pumps, the system 20 is advantageous in this respect. Furthermore, the system 20 is relatively easy to use in that fertilizer can be deposited or poured within the receptacle means within a few seconds, uses water pressure to deliver the nutrients directly to the plant, and because the nutrients are delivered to a targeted area (by way of the conduit portion 56), reduces nutrient waste.

It will be understood that numerous modifications and substitutions can be had to the aforedescribed embodiment 22 without departing from the spirit of the invention. Accordingly, the aforedescribed embodiment 22 is intended for the purpose of illustration and not as limitation.

1. A nutrient-holding and flow control system for connection in-line with the flow of water to a plant, the assembly comprising:
a receptacle having an interior into which nutrients can be positioned and including an inlet port into which water is permitted to flow into the interior of the receptacle from a source and an outlet port through which water and nutrients are permitted to exit the interior of the receptacle for delivery of water and nutrients to the plant; and
a flow controller associated with the receptacle which permits a user to alter the flow rate of water through the receptacle.

2. The system as defined in claim 1 wherein the receptacle includes an open-topped compartment portion into which the nutrients are positionable and a removable cap for selectively opening and closing the open top of the compartment portion.

3. The system as defined in claim 2 wherein the compartment portion has a bottom and substantially cylindrical sidewalls which extend upwardly from the bottom, and the removable cap is cooperable with the sidewalls of the compartment portion in a manner which permits the top to be attached to and removed from the compartment portion.

4. The system as defined in claim 3 wherein the sidewalls of the compartment portion define external threads thereabout, and the removable cap is adapted to be threadably accepted by the external threads of the compartment portion for securement of the cap to the compartment portion.

5. The system as defined in claim 1 where the inlet port is adapted to be attached to an upstream conduit to permit the delivery of water to the interior of the receptacle from a source, and the outlet port is adapted to be attached to a downstream conduit to permit the delivery of water and nutrients from the interior of the receptacle to the plant.

6. The system as defined in claim 5 wherein the inlet port is adapted to be received by an upstream conduit as the upstream conduit is directed endwise over the upstream conduit to a snug-fitting relationship thereabout, and the outlet port is adapted to be received by a discharge conduit as the discharge conduit is directed endwise over the outlet port to a snug-fitting relationship thereabout.

7. The system as defined in claim 1 wherein the inlet port and the outlet port are disposed on opposite sides of the receptacle.

8. The system as defined in claim 1 wherein the flow controller includes a manually adjustable valve which is in flow communication with the interior of the receptacle to permit a user to control the flow of water through the receptacle.

9. The system as defined in claim 8 wherein the flow controller is an infinitely-variable valve including a body defining a passageway which is connected in flow communication with the interior of the receptacle, and the manually adjustable valve includes a knob which can be rotated relative to the body of the flow controller through about ninety degrees of angular movement between fully ON and fully OFF positions.

10. The system as defined in claim 9 wherein the flow controller includes a body having a passageway which is connected in flow communication with the interior of the receptacle, and the body has a connector section which is connectable in flow communication to a water faucet.

11. A nutrient-holding and flow control system for connection in-line with the flow of water to a plant, the assembly comprising:
a receptacle having an interior into which nutrients can be positioned and including an inlet port into which water is permitted to flow into the interior of the receptacle from a source and an outlet port through which water and nutrients are permitted to exit the interior of the receptacle for delivery of water and nutrients to the plant; and
a flow controller associated with the receptacle which permits a user to alter the flow rate of water through the receptacle;
the receptacle including an open-topped compartment portion into which the nutrients are positionable and a removable cap for selectively opening and closing the open top of the compartment portion, and the inlet port is adapted to be attached to an upstream conduit to permit the delivery of water to the interior of the receptacle means from a source, and the outlet port is adapted to be attached to a downstream conduit to permit the delivery of water and nutrients from the interior of the receptacle to the plant.

12. A nutrient-holding and flow control system for connection in-line with the flow of water to a plant, the assembly comprising:
receptacle means having an interior into which nutrients can be positioned and including an inlet port into which water is permitted to flow into the interior of the receptacle from a source and an outlet port through which water and nutrients are permitted to exit the interior of the receptacle means for delivery of water and nutrients to the plant; and
flow control means associated with the receptacle which permits a user to alter the flow rate of water through the receptacle.

13. A system for use with a planter, the system comprising:
a stand for supporting the planter in a suspended condition above a floor or underlying support structure and including a center post which is arranged in a substantially vertical orientation;
a conduit for delivering water from a source to the planter, the conduit having a vertically-disposed section which extends upwardly along the center post of the stand and including an exit end through which the delivered water is directed into the planter;
a nutrient-holding receptacle for connection in-line with the flow of water to the planter through the conduit, the receptacle having an interior into which nutrients can be positioned and including an inlet port into which water is permitted to flow into the interior of the receptacle from a source and an outlet port through which water and nutrients are permitted to exit the interior of the receptacle for delivery of water and nutrients to the plant; and
a flow controller associated with the receptacle which permits a user to alter the flow rate of water through the receptacle.

14. The system as defined in claim 13 wherein the conduit further includes a horizontally-disposed section, and the outlet port of the receptacle is connected to the horizontally-disposed section so that water and nutrients which exit the receptacle through the outlet port thereof are delivered to the planter by way of the horizontally-disposed section.

15. The system as defined in claim 14 wherein the receptacle includes an open-topped compartment portion into which the nutrients are positionable and a removable cap for selectively opening and closing the open top of the compartment portion.

16. The system as defined in claim 15 wherein the compartment portion has a bottom and substantially cylindrical sidewalls which extend upwardly from the bottom and define external threads thereabout, and the removable cap is adapted to be threadably accepted by the external threads of the cooperable with the sidewalls of the compartment portion in a manner which permits the top to be threadably attached to and detached from the compartment portion.

17. The system as defined in claim 13 wherein the inlet port and the outlet port are disposed on opposite sides of the receptacle, and the outlet port is connected in a snug-fitting relationship with the horizontally-disposed section of the conduit as the horizontally-disposed section is directed endwise over the outlet port of the receptacle.

18. The system as defined in claim 13 wherein the flow controller includes a manually adjustable valve which is in flow communication with the interior of the receptacle to permit a user to control the flow of water through the receptacle.

19. The system as defined in claim 18 wherein the flow controller is an infinitely-variable valve including a body defining a passageway which is connected in flow communication with the interior of the receptacle, and the manually adjustable valve includes a knob which can be rotated relative to the body of the flow controller through about ninety degrees of angular movement between fully ON and fully OFF positions.

20. The system as defined in claim 19 wherein the flow controller includes a body having a passageway which is connected in flow communication with the interior of the receptacle, and the body has a connector section which is connectable in flow communication to a water faucet.
